(19) United States
(12) Patent Application Publication
(10) Pub. No.: US 2015/0058882 A1
(43) Pub. Date: Feb. 26, 2015

(54) METHOD AND APPARATUS FOR DETECTING AND DISPLAYING AN ALERT DURING PLAYBACK OF A RECORDED SIGNAL

(71) Applicant: THOMSON LICENSING, Issy de Moulineaux (FR)

(72) Inventors: Chaminda L. JAYAMANNE, Fishers, IN (US); David John WEAVER, Fishers, IN (US); Martin Vincent DAVEY, Indianapolis, IN (US)

(73) Assignee: THOMSON LICENSING, Issy de Moulineaux (FR)

(21) Appl. No.: 13/973,349

(22) Filed: Aug. 22, 2013

(51) Int. Cl. H04N 21/81; H04N 21/61; H04N 9/87

(52) U.S. Cl. CPC H04N 21/814; H04N 9/87; H04N 21/6125
USPC 725/33

(57) ABSTRACT

A method of displaying an alert from a broadcast source in an electronic device while the electronic device is not playing back a currently received broadcast signal is disclosed. The method comprises steps of playing back a signal recorded in a first device connected to the electronic device responsive to a user command; detecting an alert from a broadcast source while playing back the recorded signal; and presenting the alert responsive to detecting the alert.

### BACKGROUND OF THE INVENTION

1. Field of the Invention

The present principles of the embodiments generally relate to a method and apparatus for detecting and displaying an alert while a video broadcast receiver is not playing back a currently received broadcast signal and more particularly while the video broadcast receiver is playing back a signal recorded in a storage medium or a device connected to the video broadcast receiver.

2. Background Information

Many television stations have the capability of receiving weather and other emergency alerts from an alert source and broadcasting the alerts to television signal receivers. An example of an alert source is the National Oceanic and Atmospheric Administration (NOAA) Weather Radio (NWR) provided as a public service by the NOAA. When a user tunes a channel in a television signal receiver to receive content, which may be audio, video or both, from one of these stations, the user is able to hear or view a received alert broadcast in that channel. However, if the television signal receiver is playing back content pre-recorded in a storage medium of the television signal receiver, the television signal receiver does not process a broadcast signal from any channel and cannot present an alert transmitted by a television station.

Accordingly, there is a need for a television signal receiver to be able to present an alert when the television receiver is playing back pre-recorded content.

### SUMMARY OF THE INVENTION

In accordance with an aspect of the present invention, a method of displaying an alert from a broadcast source in an electronic device while the electronic device is not playing back a currently received broadcast signal is disclosed. The method comprises steps of playing back a signal recorded in a first device connected to the electronic device responsive to a user command; detecting an alert from a broadcast source while playing back the recorded signal; and presenting the alert responsive to detecting the alert.

In one embodiment, the method further comprises automatically tuning a channel by the electronic device to receive a broadcast signal from the broadcast source while playing back the recorded signal. If no useable signal is present in the channel, the electronic device automatically tunes another channel until a useable signal is found while playing back the recorded signal.

In another embodiment, the method further comprises recording the recorded signal from the broadcast source.

In another embodiment, the method further comprises pausing playback of the recorded signal while presenting the alert and resuming playback of the recorded signal in response to an event, wherein the event is one of receiving an end of the alert and receiving a user command to resume the playback of the recorded signal.

In another embodiment, the method further comprises responsive to receiving the alert, displaying a message asking a user whether to pause the playback of the recorded video; if the user indicates to pause the playback, pausing the playback of the recorded signal; and if the user indicates not to pause the playback, presenting the alert while playing back the recorded signal.

In accordance with another aspect of the present invention, an electronic device capable of receiving broadcast signals from a plurality of broadcast sources is disclosed. The electronic device comprises a memory:

and a processor executing software stored in the memory, wherein the processor is configured to play back a signal recorded in a first device connected to the electronic device responsive to a user command; detect an alert from a broadcast source while playing back the recorded signal; and presenting the alert responsive to detecting the alert.

In one embodiment, the processor is configured to automatically tune a s channel to receive a broadcast signal from the broadcast source while playing back the recorded signal and if no useable signal is present in the channel, the processor is configured to automatically tune another channel by the electronic device until a useable signal is found while playing back the recorded signal.

In one embodiment, the processor is configured to record the recorded signal from the broadcast source.

In another embodiment, the processor is configured to pause playback of the recorded signal while presenting the alert and playback of the recorded signal in response to an event, wherein the event is one of receiving an end of the alert and receiving a user command to resume the playback of the recorded signal.

In another embodiment, responsive to receiving the alert, the processor is configured to display a message asking a user whether to pause the playback of the recorded video; if the user indicates to pause the playback, pause the playback of the recorded signal; and if the user indicates not to pause the playback, present the alert while playing back the recorded signal.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

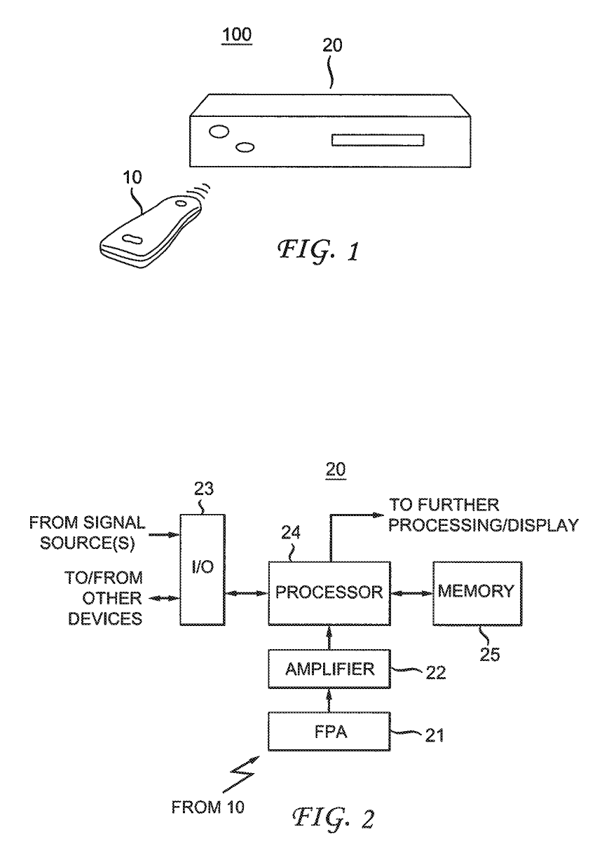

FIG. 1 shows an electronic device according to an exemplary embodiment of the present invention;

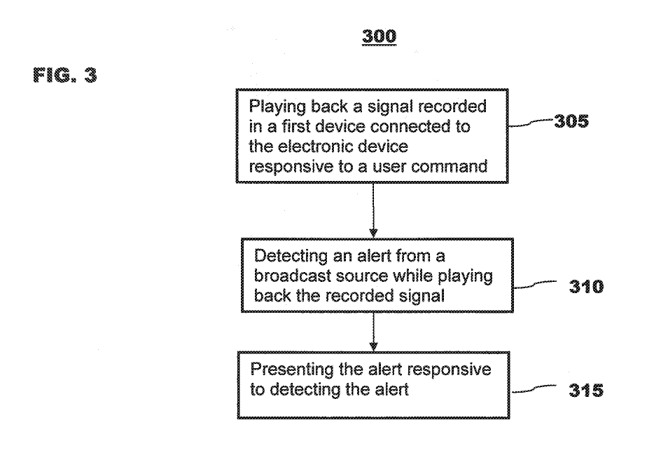

FIG. 2 shows a block diagram of the electronic device of FIG. 1 according to an exemplary embodiment of the present invention; and

FIG. 3 shows a flow diagram for presenting an alert while playing back a recorded signal by an electronic device according to an exemplary embodiment of the present invention.

The exemplifications set out herein illustrate preferred embodiments of the invention, and such exemplifications are not to be construed as limiting the scope of the invention in any manner.

### DETAILED DESCRIPTION

Referring now to the drawings, and more particularly to FIG. 1, an exemplary environment 100 suitable for implementing the present invention is shown. As indicated in FIG. 1, environment 100 comprises a user input device 10, and an electronic device 20 capable of tuning a channel for receiving broadcast signals, recording broadcast signals, and playing back recorded broadcast signals or signals recorded in a storage device connected to the electronic device 20, such as a CD, a DVD, a Blu-ray disk, a local hard disk, or a network storage. The electronic device 20 can also play back recorded signals from another playback device connected to the electronic device 20. According to an exemplary embodiment, electronic device 20 is embodied as a television signal receiver (e.g., set-top box, a Video Cassette Recorder (VCR), a personal video recorder (PVR), a hard disk recorder (HDR), or a digital video recorder (DVR), a Blu-ray player, etc.) without an integrated display device, but may be embodied as an apparatus or device that includes an integrated display device.

User input device 10 is operative or configured to generate and output control signals that control the operation of electronic device 20 and/or other devices. According to an exemplary embodiment, user input device 10 includes a plurality of input keys and outputs control signals in a wired and/or wireless (e.g., via infrared or radio frequency (RF) link, etc.) manner responsive to user depression of its input keys. User input device 10 may for example be embodied as a hand-held remote control device, wired and/or wireless keyboard, integrated control panel of electronic device 20, and/or other user input device.

Electronic device 20 is operative or configured to receive signals including audio, video and/or data signals having one or more types of analog modulation (e.g., NTSC, PAL, SECAM, etc.) and one or more types of digital modulation (e.g., QPSK, QAM, VSB, etc.) from one or more broadcast sources such as cable, terrestrial, satellite, internet and/or other signal sources and to provide aural/visual, aural only, and/or visual only outputs corresponding to these received signals. The cable, terrestrial, satellite sources may be able to broadcast alerts provided, for example, from the National Oceanic and Atmospheric Administration (NOAA) Weather Radio (NWR). It is possible that the Internet sources, such web TVs, may be able to broadcast the alerts in the future, if not now.

Electronic device 20 is operative or configured to allow instant, time-shift and timer recordings. Time-shift recording is a system that is used temporarily to store broadcast signals for later viewing, instant recording is a system for immediate recording and timer recording is a system that is used for predefined, later recording of media content. According to the principles of the embodiments, electronic device 20 detects an alert from one broadcast signal source and presents the alert during playback of a recorded signal, which can be a video program or audio program.

Electronic device 20 is also operative or configured to process received signals and provide the resulting processed signals to one or more other devices, and to receive signals from other devices, such as a DVD player, a VCR, a PVR, a HDR, a HVR, a Blu-ray player, or a storage device. These devices are unable to provide alerts from NOAA or other alert providers to electronic device 20. According to the principles of the embodiments, electronic device 20 detects an alert from one broadcast signal source and presents the alert during playback of a signal recorded in a device connected to the electronic device 20. Thus, a recorded signal may be recorded by the electronic device 20 or by other devices connected or not connected to the electronic device 20. In effect, the electronic device 20 should be able to playback a signal recorded in a recording medium associated with a device connected to the electronic device 20. The device connected to the electronic device 20 can be internal to the electronic device, such as a local memory, or external to the electronic device, such as a DVD player or a network drive. A recording medium may be a CD, DVD, hard disk, Blu-ray disk, non-volatile memory, or any combination thereof. A recorded signal received by the electronic device 20 may be in compressed, decompressed, or analog form.

Electronic device 20 is further operative or configured to provide on-screen menus for users to select whether to pause playback of a recorded signal when an alert has been detected by the electronic device 20 during the playback of a recorded signal.

In one embodiment, the electronic device 20 is operative or configured to allow a user to select whether to allow presentation of an alert during playback of a recorded program. The electronic device 20 may display an on-screen menu in response to detection of an alert allowing the user to select whether an alert should be presented or whether to pause the playback of the recorded signal while presenting the alert.

Referring to FIG. 2, a diagram providing further details of the electronic device 20 of FIG. 1 according to an exemplary embodiment of the present invention is shown. Electronic device 20 of FIG. 2 comprises front panel means such as front panel assembly (FPA) 21, amplifying means such as amplifier 22, and input/output (I/O) means such as I/O block 23, processing means such as processor 24, and memory means such as memory 25. Some of the foregoing elements of FIG. 2 may be embodied using integrated circuits (ICs), and some elements may for example be included on one or more ICs. For clarity of description, certain conventional elements associated with electronic device 20 such as certain control signals, power signals and/or other elements may not be shown in FIG. 2.

FPA 21 is operative or configured to receive user inputs from user input device 10, and to output signals corresponding to the user inputs to amplifier 22. According to an exemplary embodiment, FPA 21 receives signals, such as IR and/or RF signals, from user input device 10 and generates corresponding signals which are output to amplifier 22. Amplifier 22 is operative to amplify the signals provided from FPA 21 for output to processor 24.

I/O block 23 is operative or configured to perform I/O functions of electronic device 20. According to an exemplary embodiment, I/O block 23 is operative to receive signals such as audio, video and/or data signals in analog and digital modulation formats from one or more broadcast signal sources such as cable, terrestrial, satellite, internet and/or other signal sources. Although not expressly shown in FIG. 2, I/O block 23 may include a plurality of input terminals each designated to receive signals from a given broadcast signal source. For example, I/O block 23 may include separate input terminals for receiving signals from cable, antenna (i.e., terrestrial), satellite, internet and/or other signal sources. I/O block 23 is also operative to output processed signals to one or more other devices connected to the electronic device 20, and to receive signals from such devices. Devices connected to the electronic device 20 may include DVD players, VCRs, PVRs, HDRs, HVRs, Blu-ray players, and/or storage devices. The devices may be connected to the I/O block 23 in a wired and/or wireless manner.

Processor 24 is operative or configured to perform various signal processing and control functions of electronic device 20. According to an exemplary embodiment, processor 24 processes the audio, video and/or data signals provided from I/O block 23 by performing functions including channel tuning, analog and digital demodulation, and other functions to thereby generate data representing audio, video and/or data content. The data produced from such processing functions may be provided for further processing (e.g., MPEG decoding, etc.) and output. Also according to an exemplary embodiment, processor 24 detects and processes user inputs provided via user input device 10, and may control its own operations and/or output control signals to control other elements of electronic device 20 (including elements not shown in FIG. 2) responsive to such user inputs.

Processor 24 is also operative or configured to execute software code that automatically tunes a predefined broadcast channel during playback of a recorded signal, detects an alert from broadcast signals received from the tuned channel, and presents the alert to the user during playback of the recorded signal. If the predefined broadcast channel does not carry useable signals, processor 24 is operative or configured to tune another channel until the tuned channel carries useable signals while playing back the recorded signal. Processor 24 detects the alert in a conventional manner.

Memory 25 is operative or configured to perform data storage functions of electronic device 20. According to an exemplary embodiment, memory 25 stores data including, but not limited to, software code, electronic program guide data, user preference data, recorded audio/video signals, recorded audio only signals, recorded video only signals, and/or other data. Memory 25 may include volatile and/or non-volatile memory regions and storage devices such hard disk drives, DVD drives.

Referring now to FIG. 3, an exemplary process 300 for presenting an alert while playing back a recorded signal by an electronic device, such as electric device 20, according to the principles of the embodiments of the invention, is shown. At step 305, the processor 24 plays back a signal recorded in a first device connected to the electronic device responsive to a user command. As discussed above, the first device may be internal to the electronic device 20, such memory 25, or external to the electronic device 20, such as a DVD player or a network drive. A user may select the recorded signal from a list of files stored in memory 25 or a network drive (not shown), or select one of the input ports in the I/O block 23 for receiving the recorded signal from another device.

In one embodiment, the processor 24 records the recorded signal from a broadcast source and stores the recorded signal in the memory 25. A recorded signal as used herein is pre-recorded in a non-transitory memory and does not cover a signal temporarily stored in a transitory memory used as a transmission buffer.

The recorded signal may be an audio/video signal, such as a television program, a video only signal, such as a commercial, or an audio only signal, such as a song.

At step 310, the processor 24 detects an alert from a broadcast source while playing back the recorded signal. The processor 24 detects the alert in a conventional manner. The alert may be a weather alert or an emergency alert. The processor 24 should tune a television channel that receives signals from a broadcast source while playing back the recorded signal or when a user command to play back the recorded signal is received. The broadcast source may be a cable, terrestrial, satellite, internet and/or another signal source. The tuned channel can be a pre-defined channel, a last tuned channel, or a channel randomly selected. If the processor 24 does not detect useable signals from a tuned channel, the processor 24 should tune another channel until useable signals is received. A useable signal is a signal with a signal to noise ratio that allows the processor 24 to detect an alert if the signal includes the alert. A subsequent tuned channel may be a channel for a different broadcast source from the first tuned channel.

At step 315, the processor 24 presents the alert responsive to detecting the alert. The processor 24 may present the alert in any or any combinations of the following forms: aural, visual, textual, and closed-captioning forms.

In one embodiment, the processor 24 pauses or stops playback of the recorded video program while presenting the alert. In another embodiment, after pausing or stopping the playback, the processor 24 resumes playback of the recorded signal in response to an event. The event may be one of receiving an end of the alert and receiving a user command to resume the playback of the recorded signal.

In another embodiment, responsive to receiving the alert, the processor 24 is operative or configured to display an on-screen display message asking the user whether to pause or stop the playback of the recorded signal. If the user indicates to pause or stop the playback, the processor 24 pauses or stops the playback of the recorded signal; and if the user indicates not to pause the playback, the processor 24 displays the alert while playing back the recorded signal.

In another embodiment, the processor 24 is further operative or configured to provide on-screen menus for users to select whether to allow presentation of an alert while playing back a recorded signal.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of displaying an alert from a broadcast source in an electronic device, the method comprising:
playing back a signal recorded in a first device connected to the electronic device responsive to a user command;
detecting an alert from a broadcast source while playing back the recorded signal; and
presenting the alert responsive to detecting the alert.

2. The method of claim 1, further comprising automatically tuning a channel by the electronic device to receive a broadcast signal from the broadcast source while playing back the recorded signal.

3. The method of claim 2, further comprising if no useable signal is present in the channel, automatically tuning another channel by the electronic device until a useable signal is found while playing back the recorded signal.

4. The method of claim 1, further comprising recording the recorded signal from the broadcast source.

5. The method of claim 1, further comprising pausing playback of the recorded signal while presenting the alert.

6. The method of claim 5, further comprising resuming playback of the recorded signal in response to an event.

7. The method of claim 6, wherein the event is one of receiving an end of the alert and receiving a user command to resume the playback of the recorded signal.

8. The method of claim 1, further comprising
responsive to receiving the alert, displaying a message asking a user whether to pause the playback of the recorded video;
if the user indicates to pause the playback, pausing the playback of the recorded signal; and
if the user indicates not to pause the playback, presenting the alert while playing back the recorded signal.

9. The method of claim 1, wherein the broadcast source is an Internet broadcast source.

10. An electronic device capable of receiving broadcast signals from a plurality of broadcast sources, the electronic device comprising:
a memory: and
a processor executing software stored in the memory, wherein the processor is configured to play back a signal recorded in a first device connected to the electronic device responsive to a user command; detect an alert from a broadcast source while playing back the recorded signal; and presenting the alert responsive to detecting the alert.

11. The electronic device of claim 10, the processor is configured to automatically tune a channel to receive a broadcast signal from the broadcast source while playing back the recorded signal.

12. The electronic device of claim 11, wherein if no useable signal is present in the channel, the processor is configured to automatically tune another channel until a useable signal is found while playing back the recorded signal.

13. The electronic device of claim 10, wherein the processor is configured to record the recorded signal from the broadcast source.

14. The electronic device of claim 10, wherein the processor is configured to pause playback of the recorded signal while presenting the alert.

15. The electronic device of claim 14, wherein the processor is configured to resume playback of the recorded signal in response to an event.

16. The electronic device of claim 15, wherein the event is one of receiving an end of the alert and receiving a user command to resume the playback of the recorded signal.

17. The electronic device of claim 10, wherein responsive to receiving the alert, the processor is configured to display a message asking a user whether to pause the playback of the recorded video; if the user indicates to pause the playback, pause the playback of the recorded signal; and if the user indicates not to pause the playback, present the alert while playing back the recorded signal.

18. The electronic device of claim 1, wherein the broadcast source is an Internet broadcast source.
